(19) United States
(12) Patent Application Publication
(10) Pub. No.: US 2026/0220682 A1
(43) Pub. Date: Jul. 30, 2026

(54) RANKING CANDIDATE ITEMS USING A MULTI-DIMENSIONAL RANKER

(71) Applicant: Walmart Apollo, LLC, Bentonville, AR (US)

(72) Inventors: Shiqin Cai, Mountain View, CA (US); Yanan Cao, Mountain View, CA (US); Jayesh Uddhav Kudase, Santa Clara, CA (US); Yijie Cao, Secaucus, NJ (US); Sinduja Subramaniam, Sunnyvale, CA (US); Evren Korpeoglu, San Jose, CA (US)

(73) Assignee: Walmart Apollo, LLC, Bentonville, AR (US)

(21) Appl. No.: 19/041,642

(22) Filed: Jan. 30, 2025

(51) Int. Cl. G06Q 30/0601

(52) U.S. Cl. CPC G06Q 30/0631

(57) ABSTRACT

A method includes receiving candidate recommended items based on an item included in routine reorders of a user. For each candidate recommended item, dimension features for each dimension are embedded as embedding vectors. The dimensions include a user preference, a department affinity, a model suitability, and an item conversion potential dimension. The embedding vectors are combined into a feature vector input to a deep neural network (DNN) model to generate a ranking score representing a likelihood that the user engages with the candidate recommended item. Dimension-specific scores are obtained from intermediate layers of the DNN model including a user preference, a department affinity, a model suitability, and an item conversion potential score, which are output by a multilayer perceptron (MLP) network applied to respective embedding vectors. A final score is derived by incorporating the ranking score with respective weighted contributions. The candidate recommended items are ranked by the final scores.

### TECHNICAL FIELD

This disclosure relates generally to ranking candidate items using a multi-dimensional ranker.

### BACKGROUND

Routine orders on digital platforms offer convenience but often result in repetitive buying patterns. This repetition can hinder users from discovering novel items that align better with their evolving preferences and current shopping contexts. Traditional methods for recommending novel items typically rely on static suggestions or focus on a single dimension (e.g., user preferences or item features). These traditional methods can strain computing resources, create inefficiencies, and lead to inaccurate/irrelevant item recommendations.

### BRIEF DESCRIPTION OF THE DRAWINGS

To facilitate further description of the embodiments, the following drawings are provided in which:

FIG. 1 illustrates a front elevational view of a computer system that is suitable for implementing aspects disclosed herein, according to an example embodiment.

FIG. 2 illustrates a representative block diagram of elements included in the circuit boards inside a chassis of the computer system of FIG. 1, according to an example embodiment.

FIG. 3A illustrates a schematic block diagram of an item recommendation system that includes a system for ranking candidate items using a multi-dimensional ranker component, according to an example embodiment.

FIG. 3B illustrates a schematic block diagram of an architecture of an item recommendation system that includes a system for ranking candidate items using a multi-dimensional ranker component, according to an example embodiment.

FIG. 4 illustrates a flowchart of a computer-implemented method for ranking candidate items using a multi-dimensional ranker, according to an example embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for various lengths of time, e.g., permanent, or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DETAILED DESCRIPTION

Example embodiments described herein can address, for example, repetitive purchasing patterns on digital platforms, which can inhibit users from discovering novel items (e.g., products) that better align with their evolving preferences and current shopping contexts. Routine reordering, while convenient, often leads to a cycle of repetitive orders, limiting user exposure to novel items.

To overcome this challenge, embodiments disclosed herein can include a dynamic item discovery framework that can leverage a multi-dimensional ranker. This dynamic item discovery framework can simultaneously consider multiple dimensions, such as user preferences, department discovery intent, model suitability, and/or item conversion potential. By integrating two or more of these multiple dimensions simultaneously, the dynamic item discovery framework can adapt to various discovery scenarios, which can provide a more personalized and exploratory shopping experience.

The dynamic item discovery framework can disrupt the routine reorder loop by introducing users to items they have not previously and/or recently ordered. This approach can foster a seamless blend of familiarity and exploration of items, enhancing user engagement and satisfaction. For example, users who routinely order pet food can be recommended pet toys pursuant to a search query for the pet food, or those who buy cake mix can be introduced to baking tools and accessories during and/or after checkout of an order including the cake mix.

Novel aspects of example embodiments described herein include a dynamic and adaptive nature. The multi-dimensional ranker can optimize item recommendations across multiple dimensions, going beyond static ranking methods. The model suitability dimension can enable cross-model preference learning, dynamically selecting the best recommendation strategy/strategies—whether it be for similar items, complementary items, cross-pollination/category items, or a blend thereof—for different contexts. This approach can surpass traditional one-model-fits-all methods by tailoring recommendations based on diverse user intents and/or scenarios.

A unified, final score generated by the multi-dimensional ranker can tailor item recommendations at a micro (item level) and/or a macro (department and model level) scale, making it adaptable to various item discovery scenarios/strategies. Embodiments disclosed herein can provide personalized item discovery recommendations to users, breaking the routine order loop and driving a more dynamic and exploratory shopping experience.

Among the improvements that can be conferred on digital platforms are enhanced computational efficiency, more accurate and relevant recommendations, and improved user satisfaction. By dynamically integrating multiple recommendation objectives, the framework can optimize the use of computational resources, reducing redundant calculations and improving processing speed. This multi-dimensional approach can provide that recommendations are precise and contextually relevant, aligning with users' evolving preferences and/or current shopping contexts. Additionally, the adaptive nature of the ranking candidate items using a multi-dimensional ranker allows it to respond to dynamic/real-time changes in user behavior, providing timely and pertinent suggestions. This real-time adaptability can enhance user satisfaction and engagement. The efficient use of system resources, achieved through the integration of multiple recommendation objectives, can allow the digital platform to handle larger volumes of data and interactions without compromising performance. This results in a scalable and robust item recommendation engine that benefits both the digital platform and its users.

Furthermore, digital platform specialists can modify the dimension-specific weighted contributions of the dimensions, which can concurrently adjust the weights and/or biases of upstream and/or downstream components and processes. This bidirectional capability enables the creation of novel and precise strategies for item recommendation, enhancing the cooperative efficiency of components within the overall system.

Empirical evaluations of embodiments disclosed herein corroborate these improvements. Among these improvements were increased item discovery associated with items included in routine reorders, a rise in average order size and value, and enhancements in key performance metrics such as user engagement and overall sales. Statistically significant positive results were demonstrated across both mobile and web platforms, indicating the effectiveness of the dynamic discovery framework in various contexts.

For instance, user engagement metrics showed significant improvements, with engagement scores increasing by 28 basis points on mobile platforms and 51 basis points on web platforms. Additionally, the total engagement points per visitor increased by 2.3% on mobile and 1.0% on web platforms, demonstrating the framework's ability to enhance user interaction and satisfaction.

According to an example embodiment, a system is provided. The system includes one or more processors and one or more non-transitory computer-readable medium storing computing instructions. The computing instructions, when executed on the one or more processors, perform various processes including a computer-implemented method. The computer-implemented method includes, for each candidate recommended item from among candidate recommended items, embedding, by a multi-dimensional ranker component, dimension features associated with each dimension from among multiple dimensions as respective embedding vectors. The multiple dimensions include a user preference dimension, a department affinity dimension, a model suitability dimension, and an item conversion potential dimension. The dimension features for the item conversion potential dimension include item features associated with a candidate recommended item from among the candidate recommended items for a user. The respective embedding vectors of the dimension features associated with the multiple dimensions are combined, by the multi-dimensional ranker component, into a combined feature vector. The combined feature vector is input, to a deep neural network (DNN) model included in the multi-dimensional ranker component, to generate a ranking score. The ranking score represents a predicted likelihood that the user will engage with the candidate recommended item from among the candidate recommended items. A final score is derived, by the multi-dimensional ranker component, by incorporating the ranking score with respective weighted contributions for each dimension of the multiple dimensions. The candidate recommended items are ranked as ranked candidate recommended items based on the final score for each candidate recommended item from among the candidate recommended items.

According to an example embodiment, a computer-implemented method is provided. The computer-implemented method includes receiving candidate recommended items at least partially based on at least one item included in routine reorders of a user. For each candidate recommended item from among the candidate recommended items, dimension features associated with each dimension from among multiple dimensions are embedded as respective fixed-length embedding vectors. The multiple dimensions include a user preference dimension, a department affinity dimension, a model suitability dimension, and an item conversion potential dimension. The dimension features for the item conversion potential dimension include item features associated with a candidate recommended item from among the candidate recommended items for the user. The respective fixed-length embedding vectors of the dimension features associated with the multiple dimensions are combined into a combined feature vector. The combined feature vector is input to a deep neural network (DNN) model to generate a ranking score. The ranking score represents a predicted likelihood that the user will engage with the candidate recommended item from among the candidate recommended items for the user. Dimension-specific scores are obtained from intermediate layers of the DNN model. The dimension-specific scores include a user preference score, a department affinity score, a model suitability score, and an item conversion potential score. Each of the dimension-specific scores is output by a small multilayer perceptron (MLP) network applied to a respective fixed-length embedding vector from among the respective fixed-length embedding vectors, independently. A final score is derived by incorporating the ranking score with respective weighted contributions for each dimension of the multiple dimensions. The candidate recommended items are ranked as ranked candidate recommended items based on the final score for each candidate recommended item from among the candidate recommended items.

According to an example embodiment, a computer-readable medium is provided storing instructions that, when executed by a processor, cause the processor to perform a computer-implemented method. The computer-implemented method includes receiving candidate recommended items at least partially based on at least one item included in routine reorders of a user. For each candidate recommended item from among the candidate recommended items, dimension features associated with each dimension from among multiple dimensions are embedded as respective fixed-length embedding vectors. The multiple dimensions include a user preference dimension, a department affinity dimension, a model suitability dimension, and an item conversion potential dimension. The dimension features for the item conversion potential dimension include item features associated with a candidate recommended item from among the candidate recommended items for the user. The respective fixed-length embedding vectors of the dimension features associated with the multiple dimensions are combined into a combined feature vector. The combined feature vector is input to a deep neural network (DNN) model to generate a ranking score. The ranking score represents a predicted likelihood that the user will engage with the candidate recommended item from among the candidate recommended items for the user. Dimension-specific scores are obtained from intermediate layers of the DNN model. The dimension-specific scores include a user preference score, a department affinity score, a model suitability score, and an item conversion potential score. A final score is derived by incorporating the ranking score with respective weighted contributions for each dimension of the multiple dimensions. The candidate recommended items are ranked as ranked candidate recommended items based on the final score for each candidate recommended item from among the candidate recommended items.

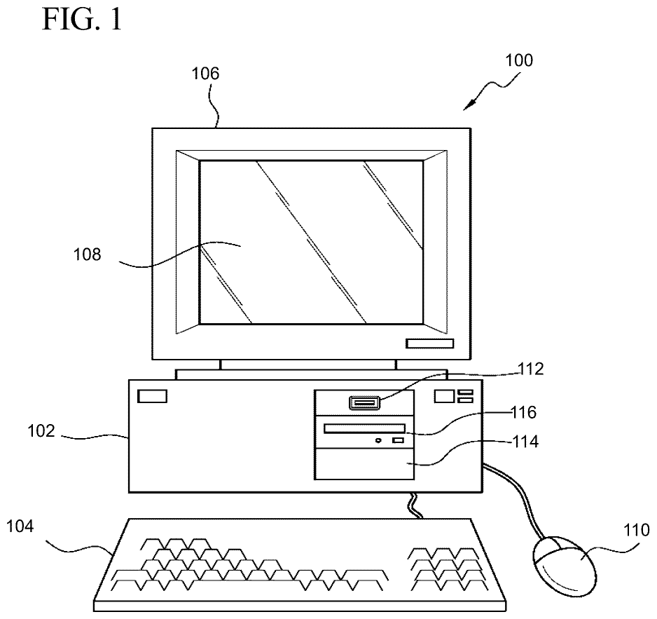

FIG. 1 illustrates a front elevational view of a computer system that is suitable for implementing aspects disclosed herein, according to an example embodiment.

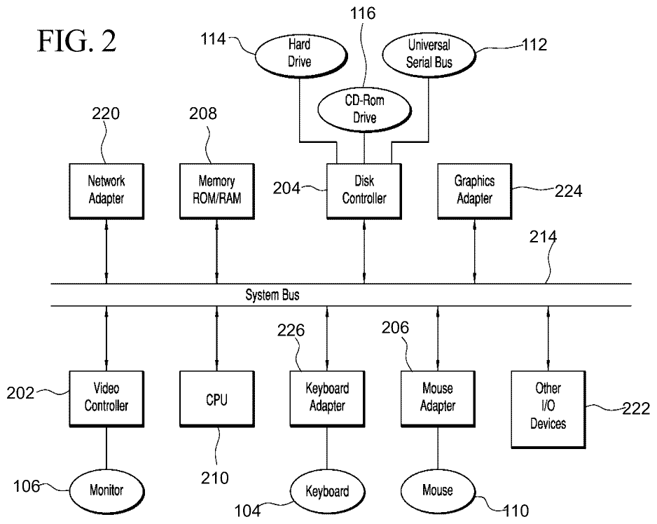

FIG. 2 illustrates a representative block diagram of elements included in the circuit boards inside a chassis of the computer system of FIG. 1, according to an example embodiment.

FIG. 1 illustrates an example embodiment of a computer system 100, all of which or a portion of which can be suitable for (i) implementing at least partial or all example embodiments of the techniques, methods, and systems and/or (ii) implementing and/or operating part or all example embodiments of the non-transitory computer readable media described herein. As an example, a different or separate one of the computer system 100 (and its internal components, or at least one element of the computer system 100) can be suitable for implementing partial or all the techniques described herein. The computer system 100 can comprise a chassis 102 which can contain at least one circuit boards (not shown), a Universal Serial Bus (USB) port 112, a Compact Disc Read-Only Memory (CD-ROM), a Digital Video Disc (DVD) drive 116, and/or a hard drive 114. A representative block diagram of the elements included on the circuit boards inside the chassis 102 is shown in FIG. 2, according to an example embodiment. A central processing unit (CPU) 210 illustrated in FIG. 2 can be coupled to a system bus 214 in FIG. 2. In various example embodiments, an architecture of the CPU 210 can be compliant with a variety of commercially distributed architecture families.

Continuing with FIG. 2, the system bus 214 can be coupled to at least one memory storage unit 208 that can include both read only memory (ROM) and random access memory (RAM). Non-volatile portions of the memory storage unit 208 and/or the ROM can be encoded with a boot code sequence suitable for restoring the computer system 100 (FIG. 1) to a functional state, such as after a system reset. In addition, the memory storage unit 208 can include microcode, such as a Basic Input-Output System (BIOS). In some example embodiments, the at least one memory storage units of the various embodiments disclosed herein can include the memory storage unit 208, a USB-equipped electronic device (e.g., an external memory storage unit (not shown) coupled to the USB port 112 (FIGS. 1-2), the hard drive 114 (FIGS. 1-2), the CD-ROM, the DVD, the Blu-Ray, and/or other suitable media, such as media configured to be used for the CD-ROM and/or the DVD drive 116 (FIGS. 1-2). Non-volatile and/or non-transitory memory storage unit(s) can refer to the portions of the memory storage units(s) that are non-volatile memory and are not transitory signals. In the same or different example embodiments, the at least one memory storage units of the various embodiments disclosed herein can include an operating system, which can be a software program that manages the hardware and software resources of a computer and/or a computer network. The operating system can perform tasks such as, for example, at least one of controlling and/or allocating memory, prioritizing the processing of instructions, controlling input and/or output devices, facilitating networking, and/or managing files. Example operating systems can include at least one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further example operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing component” can mean various types of computational circuits, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, and/or various other types of processors and/or processing circuits capable of performing the desired functions. In some example embodiments, the at least one processors of the various embodiments disclosed herein can comprise the CPU 210.

In the example embodiment illustrated in FIG. 2, various I/O devices such as a disk controller 204, a graphics adapter 224, a video controller 202, a keyboard adapter 226, a mouse adapter 206, a network adapter 220, and/or other I/O devices 222 can be coupled to the system bus 214. The keyboard adapter 226 and/or the mouse adapter 206 can be coupled to a keyboard 104 (FIGS. 1-2) and/or a mouse 110 (FIGS. 1-2), respectively, of the computer system 100 (FIG. 1). The graphics adapter 224 and/or the video controller 202 can be indicated as distinct units in FIG. 2, the video controller 202 can be integrated into the graphics adapter 224, or vice versa in other example embodiments. The video controller 202 can be suitable for refreshing a monitor 106 (FIGS. 1-2) to display images on a screen 108 (FIG. 1) of the computer system 100 (FIG. 1). The disk controller 204 can control the hard drive 114 (FIGS. 1-2), the USB port 112 (FIGS. 1-2), the CD-ROM, and/or the DVD drive 116 (FIGS. 1-2). In other example embodiments, distinct units can be used to control each of these devices separately.

In some example embodiments, the network adapter 220 can comprise and/or be implemented as a WNIC (wireless network interface controller) card (not shown) plugged and/or coupled to an expansion port (not shown) in the computer system 100 (FIG. 1). In other example embodiments, the WNIC card can be a wireless network card built into the computer system 100 (FIG. 1). A wireless network adapter can be built into the computer system 100 (FIG. 1), such as by having wireless communication capabilities integrated into the motherboard chipset (not shown) or implemented via at least one dedicated wireless communication chips (not shown), connected through a PCI (peripheral component interconnector), a PCI express bus of the computer system 100 (FIG. 1), and/or the USB port 112 (FIG. 1). In other example embodiments, the network adapter 220 can comprise and/or be implemented as a wired network interface controller card (not shown).

Although some components of the computer system 100 (FIG. 1) might not be shown in the figures, such components and their interconnection may be appreciated by those of ordinary skill in the art. Accordingly, further details concerning the construction and/or composition of the computer system 100 (FIG. 1) and/or the circuit boards inside the chassis 102 (FIG. 1) might be omitted herein.

When the computer system 100 in FIG. 1 is running, program instructions stored on a USB drive in the USB port 112, on the CD-ROM, the DVD in the CD-ROM, and/or the DVD drive 116, on the hard drive 114, and/or in the memory storage unit 208 (FIG. 2) can be executed by the CPU 210 (FIG. 2). At least a portion of the program instructions, such as stored on at least one of these devices, can be suitable for carrying out all or at least a part of the techniques described herein. In various example embodiments, the computer system 100 can be reprogrammed with at least one of at least one component, system, application, and/or database, such as those described herein, to convert a general purpose computer to a special purpose computer. For purposes of illustration, programs and other executable program components are shown herein as discrete systems, although it is understood that such programs and components may reside, at various times, in different storage components of the computer system 100, and can be executed by the CPU 210. Additionally, or alternatively, the systems and/or procedures described herein can be implemented in hardware, and/or a combination of hardware, software, and/or firmware. For example, at least one application specific integrated circuit (ASIC) can be programmed to carry out at least one of the systems and procedures described herein. For example, at least one of the programs and/or executable program components described herein can be implemented in at least one ASIC.

Although the computer system 100 is illustrated as a desktop computer with reference to FIG. 1, it is not limited thereto. The computer system 100 can take a different form factor and can still having functional elements like those described with respect to the computer system 100. In some example embodiments, the computer system 100 can comprise at least one of at least one single computer, a single server, a cluster/collection of computers/servers, and/or a cloud of computers/servers. Typically, a cluster or collection of servers can be used when the demand on the computer system 100 exceeds the reasonable capability of a single server and/or computer. In some example embodiments, the computer system 100 can comprise a portable computer, such as a laptop computer. In some example embodiments, the computer system 100 can comprise a mobile device, such as a smartphone. In some example embodiments, the computer system 100 can comprise an embedded system.

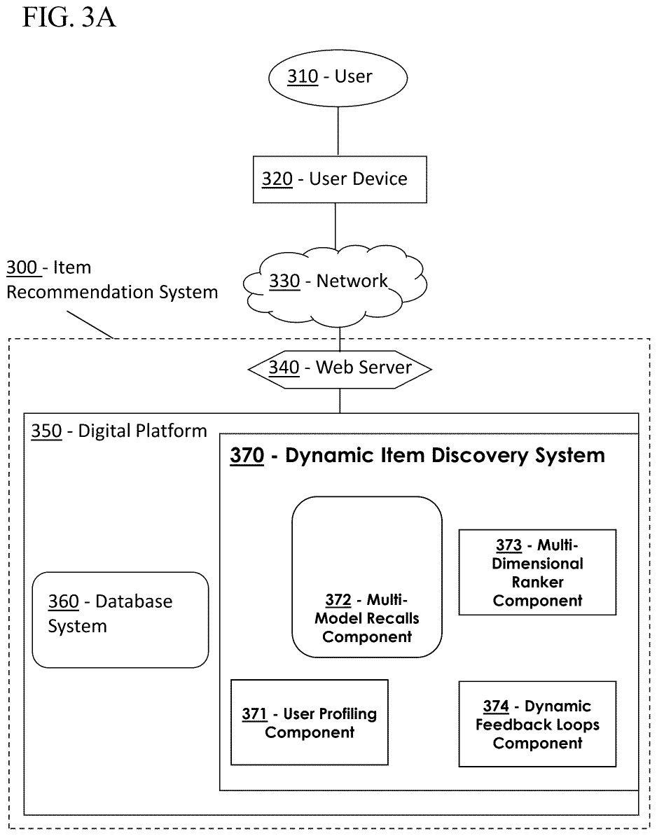

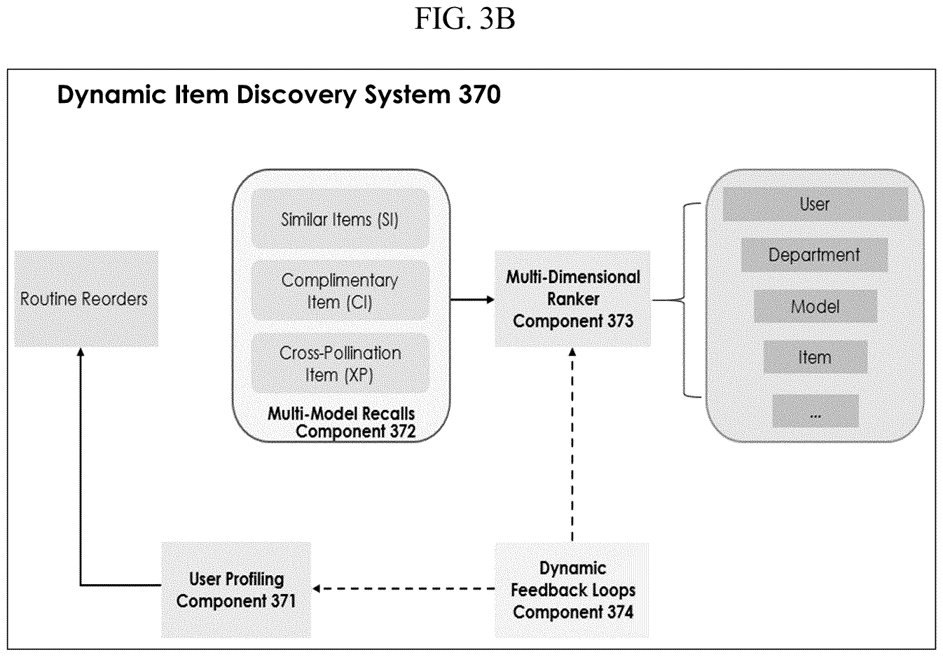

FIG. 3A illustrates a schematic block diagram of an item recommendation system that includes a system for ranking candidate items using a multi-dimensional ranker component, according to an example embodiment.

FIG. 3B illustrates a schematic block diagram of an architecture of an item recommendation system that includes a system for ranking candidate items using a multi-dimensional ranker component, according to an example embodiment.

### Item Recommendation System 300

The item recommendation system 300 can include a dynamic item discovery system 370, a web server 340, a digital platform 350, and/or a database system 360 for storing and/or accessing various types of data. The web server 340 can connect to at least one user device 320 of at least one user 310, such as via a network 330. The digital platform 350 can include the dynamic item discovery system 370 and/or the database system 360. The dynamic item discovery system 370 can include a multi-dimensional ranker component 373. The dynamic item discovery system 370 can further include a user profiling component 371, a multi-model recalls component 372, and/or a dynamic feedback loops component 374. The multi-models recalls component 372 can include one or more recall type models corresponding to one or more respective recall types for generating one or more candidate recommended items (e.g., similar item (SI), complimentary item (CI), cross-pollination/category item, a blend thereof, etc.) associated, for example, based on analyzed user data, user feedback, an item detected based on dynamic user engagement and/or dynamic user browsing behaviors, and/or an item included in routine reorders of the user a threshold quantity of times during a predetermined period of time. The multi-dimensional ranker component 373 can include a deep neural network (DNN).

The digital platform 350 can include, for example, an e-commerce platform, a digital storefront, an online marketplace, a virtual storefront, and/or an online retail store, etc.

The various types of data stored and/or accessed by the database system 360 can include, for example, user feedback, user data, user engagement signals, user browsing behaviors, user preference features, model suitability features, item conversion potential features, department affinity features, embedding vectors, DNN-based ranking scores, dimension-specific scores, final scores, dimension-specific weighted contributions and/or biases, cataloged items (e.g., items), items included in routine reorders, candidate recommended items, ranked candidate recommended, recommended items, thresholds for recommend items, department affinity features, item conversion potential features, user preference features, model suitability features, recall type models' weights and/or biases, etc.

The at least one user 310 can be, for example, a digital platform customer or a digital platform data specialist.

The item recommendation system 300 can provide a dynamic solution that integrates multiple recommendation objectives into a unified and adaptive system.

### User Profiling Component 371

The user profiling component 371 can collect and/or update (e.g., continuously) user data and can generate a comprehensive profile of the user's shopping habits. The user profiling component 371 can gather user data from various sources, including routine order history, browsing behavior (e.g., pages visited, time spent on pages, search queries, navigational paths of items/pages), and engagement signals (e.g., clicks, views, add-to-cart actions, order completions) of the at least one user 310. The component analyzes this data to identify patterns and/or trends in the user's behavior, such as the frequency of orders, the categories and/or subcategories of items ordered, and any seasonal patterns, etc. This analysis of the user data can be performed using machine learning algorithms for feature extraction and/or pattern recognition, which can enable the item recommendation system 300 to provide personalized candidate item recommendations and improve user engagement and/or conversion.

The user profiling component 371 can analyze the user data to identify routine reorders and preferred items. The user profiling component 371 can track user interactions (e.g., clicks, views, add-to-cart actions, order completions, etc.) to gauge interest and engagement. The user profiling component 371 can monitor the recency and/or frequency of orders to detect patterns in shopping behavior. Additionally, the user profiling component 371 can identify favored categories and/or subcategories to tailor item recommendations and/or item promotions. The user profiling component 371 can also analyze browsing behavior to understand user interests and preferences (e.g., frequently visited pages, common search queries, navigational paths of items/pages, etc.).

The user profiling component 371 can receive the user data from at least one of the database system 360 or the dynamic feedback loops component 374. This user data can include orders, browsing behaviors, and/or engagement signals of the at least one user 310. The dynamic feedback loops component 374 can collect and/or update (e.g., continuously) the user data based on real-time interactions, which can provide that the profile of the at least one user 310 remains current and reflective of the user's latest behavior. This substantially real-time updating can allow the system to quickly adapt to changes in user behavior, which can enhance the accuracy and personalization of item recommendations. The analysis of user feedback can overlap with the analysis of historical user data in several areas, such as identifying routine reorders, tracking engagement metrics, monitoring order frequencies, and/or analyzing browsing behaviors, etc.

The user preference features analyzed and extracted by the user profiling component 371 can be used by the multi-dimensional ranker component 373 (e.g., with respect to user preference features of the user preference dimension). The multi-model recalls component 372 can receive the analyzed and/or extracted features from the user data, including items in routine reorders and/or identified in real-time/dynamic user data/feedback from the dynamic feedback loops component 374. This data can be related to user interactions with the presentation of candidate recommended items (e.g., recommended items). The multi-model recalls component 372 can select at least one candidate recommended item recall type and/or recall model to generate the candidate recommended items. The candidate recommended items that can be output by the recall type model in the multi-model recalls component 372 can be affected by the input of the analyzed and/or extracted features of the user data from the user profiling component 371.

### Multi-Model Recalls Component 372

The multi-model recalls component 372 can enable a hybrid recall strategy that can allow a selection and/or a blending of different types of recalls (e.g., similar items (SI), complimentary items (CI), cross-pollination/category items (XP)) for richer discovery experiences, tuned to the user's current engagement context, based on the analyzed and/or extracted features received from the user profiling component 371. The analyzed and/or extracted features from the user profiling component 371 can be used by the multi-model recalls component 372 to generate candidate recommended items of one or more recall types, for example, at least partially based on at least one item included in the routine reorders and/or identified in the context of a current user shopping session. This approach can provide that the candidate item recommendations are diverse and aligned with the user's evolving preferences.

The multi-model recalls component 372 can generate candidate recommended items via a selected recall type model by leveraging a hybrid recall strategy that selects at least one recall type and/or blends different recall types. This strategy can include recall types for candidate recommended item generation corresponding to similar items (SI), complimentary items (CI), and/or cross-pollination/category items (XP), providing a richer discovery experience tailored to the user's current engagement context. By using the analyzed features from the user profiling component 371, the multi-model recalls component 372 can provide that the generated candidate item recommendations are diverse and aligned with the user's evolving preferences.

### Multi-Dimensional Ranker Component 373

The multi-dimensional ranker component 373 can generate a comprehensive ranking score for each candidate recommended item received from the multi-model recalls component 372 and can optimize across different dimensions to maximize discovery and/or conversion. The multi-dimensional ranker component 373 can optimize across multiple dimensions (e.g., user preferences, item-level features, department discovery intent, model suitability, etc.). The model suitability dimension can enable the multi-dimensional ranker component 373 to perform cross-model (e.g., recall type model) preference learning, dynamically selecting the best recommendation strategy (e.g., SI, CI, XP, etc.) for different contexts. This approach can optimize the candidate recommended item ranking and/or ultimate recommended items based on diverse user intents and/or scenarios, making the recommendations adaptable to various discovery scenarios.

The multi-dimensional ranker component 373 can integrate the multiple dimensions' features (e.g., respective embedding vectors) to produce a unified, final ranking score, such as using a deep neural network (DNN) based model that captures cross-dimensional interactions and/or weighted contributions. This final ranking score can consider multiple dimensions (e.g., user, department, model, item) simultaneously. For example, a higher weight can be automatically selected and/or assigned by a digital platform specialist to model dimension(s) to prioritize specific model strategies or to the department dimension to promote discovery in specific categories.

The multi-dimensional ranker component 373 can embed dimension features associated with two or more dimensions (e.g., each) from among multiple dimensions as respective embedding vectors (e.g., fixed-length). These multiple dimensions can include a user preference dimension, a department affinity dimension, a model suitability dimension, and/or an item conversion potential dimension.

User preference dimension features can include order history, user engagement metrics, recency and/or frequency of past orders, items included in routine orders, items identified in dynamic/real-time user data, and/or preferred categories and subcategories.

Item conversion potential features can include item (e.g., a candidate recommended item) attributes (such as brand, price, and/or ratings), historical conversion score, and/or item novelty.

Department Affinity Features can include the popularity of the department related to the item (e.g., the candidate recommended item) within the user base, the department's alignment with past user orders, and/or seasonal relevance (e.g., trending items).

Model Suitability Features can include the type of recommendation (e.g., SI, CI, and/or XP) for the item (e.g., the candidate recommended item) and/or the historical success rate for each recall type model (e.g., ATCr, CTR).

One or more of these dimension-specific features can be received/obtained from one or of the user profiling component 371, the dynamic feedback loops component 374, and/or the database system 360.

The multi-dimensional ranker component 373 can combine the respective embedding vectors of the dimension features associated with the multiple dimensions into a combined feature vector. This combined feature vector can be input to the deep neural network (DNN) model (e.g., included in the multi-dimensional ranker component 373) to generate a ranking score. The ranking score can represent a predicted likelihood that the at least one user 310 will engage with the candidate recommended item from among the candidate recommended items. The multi-dimensional ranker component 373 can derive a unified, final score by incorporating the ranking score with respective weighted contributions for each dimension of the multiple dimensions, ranking the candidate recommended items as ranked candidate recommended items based on the final score for each candidate recommended item from among the candidate recommended items.

The multi-dimensional ranker component 373 can obtain dimension-specific scores (e.g., from intermediate layers of the DNN model). These dimension-specific scores can include a user preference score, a department affinity score, a model suitability score, and/or an item conversion potential score. For example, each of the dimension-specific scores can be output by a small multilayer perceptron (MLP) network applied to a respective embedding vector from among the embedding vectors, independently. The inputting of the combined feature vector to the DNN model to generate the ranking score further can include applying a sigmoid function to the combined feature vector.

For example:

### Step 1: Feature Embedding Across Dimensions

Dimension k=4: User, Department, Model, and Item.

Each dimension's features can be encoded as embedding vectors (e.g., fixed-length), and the combined feature vector x can be represented as:

$$x = [ {f}_{u} , {f}_{d} , {f}_{m} , {f}_{i} ]$$

fᵤ ∈ [symbol] ^{L}, f_{d} ∈ [symbol] ^{M}, fₘ ∈ [symbol] ^{N}, and fᵢ ∈ [symbol] ^{P} can represent embedding vectors of each dimension.

The combined feature vector x ∈ [symbol] ^{(L+M+N+P)} can be the input to the DNN.

### Step 2: DNN-Based Ranking Score

This DNN-based ranking score can be the output of the DNN model that can combine features from all multiple (e.g., four) dimensions (user preference dimension, department affinity dimension, model suitability dimension, and/or item conversion potential dimension, etc.). This DNN-based ranking score can represent the predicted likelihood that the at least one user 310 will engage with (e.g., click or order) a recommended item (e.g., a candidate recommended item).

$$Ranking Score = σ ( DNN ( x ) )$$

x can represent the concatenated feature vector, and a can represent the sigmoid function.

### Step 3: Dimension-Specific Scores

Dimension-specific scores can be obtained from intermediate layers of the DNN model which can represent the individual impact of each dimension.

$$User Preference Score = σ ( {MLP}_{u} ( {f}_{u} ) )$$

$$Department Affinity Score = σ ( {MLP}_{d} ( {f}_{d} ) )$$

$$Model Suitability Score = σ ( {MLP}_{m} ( {f}_{m} ) )$$

$$Item Conversion Potential Score = σ ( {MLP}_{i} ( {f}_{i} ) )$$

MLPᵤ, MLP_{d}, MLPₘ, MLPᵢ can represent small MLP networks applied to each dimension's features independently.

### Step 4: Optimization and Weighting Across Dimensions

The Final Score can be derived by incorporating the Ranking Score along with the weighted contributions of the individual dimension scores:

$$Final score = {w}_{0} \cdot Ranking Score + {w}_{u} \cdot User Score + {w}_{d} \cdot Department Score + {w}_{m} \cdot Model Score + {w}_{i} \cdot Item Score$$

[symbol] ₀, [symbol] ᵤ, [symbol] _{d}, [symbol] ₘ, [symbol] ᵢ can be learned, dynamically, and or manually set weights that control the importance of each component dimension in the final recommendation score.

The Final Score can be used to rank items (e.g., candidate recommended items) in the recommendation system, which can allow the framework to tailor the rankings to optimize for different objectives.

### Dynamic Feedback Loops Component 374

The dynamic feedback loops component 374 can identify dynamic/real-time user data related to at least one of at least one preferred item, at least one candidate recommended item, and/or at least one recommended item. The dynamic feedback loops component 374 can adjust the weight of each recommendation type dynamically based on the dynamic/real-time user data, such as user engagement patterns and/or user browsing behaviors related the preferred item, the candidate recommended item, and/or the recommended item during a current shopping session. The dynamic feedback loops component 374 can refine and introduce (e.g., continuously) novel exploration strategies when users show signs of engagement fatigue (e.g., reduced interaction rates, repeated exposure to the same items without action, reduced user engagement, etc.), which can provide a consistently fresh experience. The dynamic feedback loops component 374 can continuously update the user data based on real-time interactions, which can provide that the user profile remains current and reflective of the user's latest behavior. This substantially real-time/dynamic updating allows the dynamic item discovery system 370 to quickly adapt to changes in user behavior, enhancing the accuracy and personalization of item recommendations.

The dynamic feedback loops component 374 can update (e.g., continuously) the user data based on real-time interactions, which can provide that the user profile remains current and reflective of the user's latest behavior. The dynamic feedback loops component 374 can adjust the weights and/or biases of each recall type and/or recall type model dynamically based on user engagement patterns (e.g., clicks, add-to-cart actions, orders, show/hides, etc.). The dynamic feedback loops component 374 can also introduce novel exploration strategies when users show signs of engagement fatigue (e.g., reduced interaction rates, repeated exposure to the same items without action, repetitious query searches for related terms, etc.), which can provide a fresh experience. This substantially real-time/dynamic updating can allow the dynamic item discovery system 370 to quickly adapt to changes in user data, enhancing the accuracy and personalization of recommendations.

In one embodiment, the dynamic item discovery system 370 (e.g., the multi-dimensional ranker component 373) can display at least one recommended item that corresponds to at least one ranked candidate recommended item from among the ranked candidate recommended items. This display can be based on at least one predetermined final value or at least one predetermined ranking position. The display and/or generated computer-readable program instructions therefor can be transmitted to the at least one user 310 of the at least one user device 320. This can be presented in various discovery touchpoints within the user experience (UX), such as discovery on different platforms, search results, and/or a cart page, etc. For instance, an inspiration carousel within the UX can be utilized to display at least one recommended item that corresponds to at least one ranked candidate recommended item from among the ranked candidate recommended items, based on at least one predetermined final value or at least one predetermined ranking position.

This integrated approach can provide that the item recommendation system 300 effectively understands and predicts user behavior, leading to a more personalized and engaging user experience. The item recommendation system 300 can display at least one recommended item that corresponds to at least one ranked candidate recommended item from among the ranked candidate recommended items based on at least one of at least one predetermined final value or at least one predetermined ranking position, such as with reference to respective thresholds therefor.

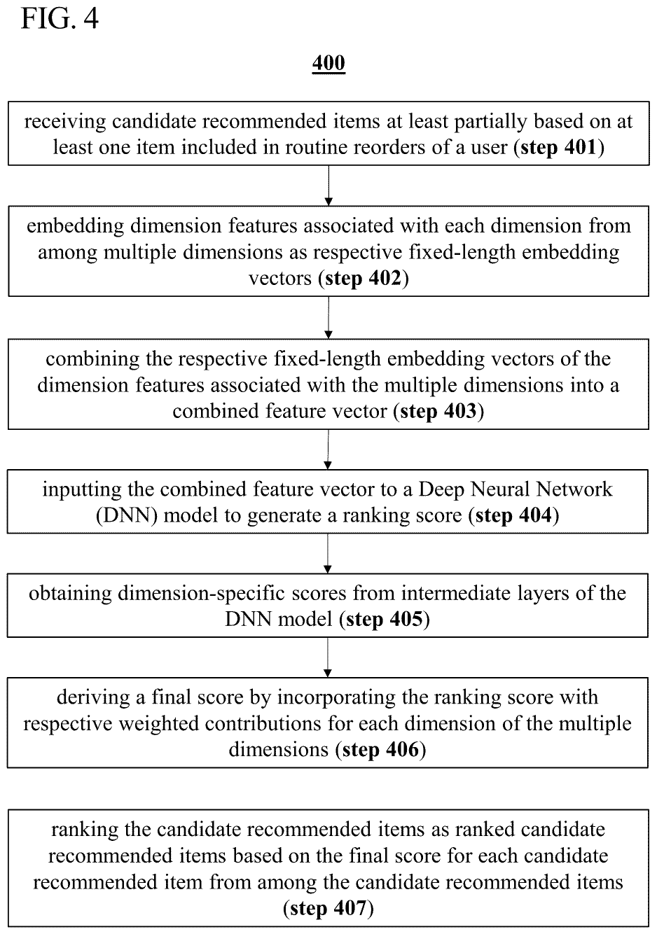

The item recommendation system 300 can include a processor and/or a non-transitory computer-readable medium storing computing instructions that, when executed on the processor, can cause the processor to perform various operations, including a computer-implemented method (e.g., a computer-implemented method 400 for ranking candidate items using a multi-dimensional ranker, according to the example embodiment shown and described with reference to FIG. 4, described below).

The item recommendation system 300 and/or the system components thereof can each include a computer system, such as the computer system 100 (illustrated and described with respect to FIG. 1), and one or more can be a single computer; a single server; a cluster or collection of computers or servers; a cloud of computers or servers; and/or a combination thereof. In some example embodiments, a single computer system can host the item recommendation system 300 and/or the system components thereof.

The network 330 can be the Internet or another suitable network for inter-device connectivity. In some example embodiments, the web server 340 can host the item recommendation system 300, websites connected thereto (e.g., the digital platform 350), and/or mobile application servers, etc. For example, the web server 340 can host the item recommendation system 300, a website connected thereto, and/or the system components of the item recommendation system 300, and/or can provide a server that interfaces with an application (e.g., a mobile application) on the at least one user device 320. This can allow for the at least one user 310 to passively and/or actively engage with the item recommendation system 300 and/or the system components thereof.

In some example embodiments, an internal network that is not open to the public can be used for communications between the item recommendation system 300 and the system components thereof. Accordingly, in some example embodiments, the item recommendation system 300, the system components thereof, and/or associated software can refer to a back end of a system operated by a network administrator of the item recommendation system 300. The web server 340 and/or the item recommendation system 300 (and/or software used by such systems) can refer to a front end of system, which can be accessed and/or otherwise used by the at least one user 310 via the at least one user device 320. In these or other example embodiments, the network administrator of the item recommendation system 300 can manage the item recommendation system 300 and/or the system components thereof, the processor(s) of the item recommendation system 300, and/or the memory storage unit(s) of the item recommendation system 300 using the input device(s) and/or display device(s) of the item recommendation system 300.

In some example embodiments, the at least one user device 320 can include a desktop computer, a laptop computer, a mobile device, and/or another endpoint device used by the at least one user 310. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.).

In some example embodiments, the item recommendation system 300 and/or the system components thereof can each include at least one input device (e.g., at least one keyboards, at least one keypads, at least one pointing devices such as a computer mouse or computer mice, at least one touchscreen displays, a microphone, etc.), and/or can include at least one display device (e.g., at least one monitor, at least one touch screen display, projector, etc.). In these example embodiments or other example embodiments, at least one of the input device(s) can be similar or identical to the keyboard 104 (FIG. 1) and/or the mouse 110 (FIG. 1). Further, at least one of the display device(s) can be similar or identical to the monitor 106 (FIG. 1) and/or the screen 108 (FIG. 1). The input device(s) and the display device(s) can be coupled to the item recommendation system 300 and/or the system components thereof in a wired manner and/or a wireless manner, and the coupling can be direct and/or indirect, as well as local and/or remote. As an example of an indirect manner (which may or may not also be a remote manner), a keyboard-video-mouse (KVM) switch can be used to couple the input device(s) and the display device(s) to the processor(s) and/or the memory storage unit(s). In some example embodiments, the KVM switch also can be part of the item recommendation system 300 and/or the system components thereof. In a similar manner, the processors and/or the non-transitory computer-readable media can be local and/or remote to each other.

The item recommendation system 300 and/or the system components thereof can be stored in at least one memory storage units (e.g., non-transitory computer readable media), which can be similar or identical to the at least one memory storage units (e.g., non-transitory computer readable media) described above with respect to the computer system 100 (FIG. 1). Also, in some embodiments, at least one database (e.g., the database system 360)/repositories included and/or connected to the item recommendation system 300, and/or the system components thereof can be stored on a single memory storage unit, or the contents of that database can be spread across multiple ones of the memory storage units storing the at least one databases, depending on the size of the database and/or the storage capacity of the memory storage units.

The at least one database can include a structured (e.g., indexed) collection of data and can be managed by a suitable database management systems configured to define, create, query, organize, update, and manage database(s). Example database management systems can include MySQL (Structured Query Language) Database, PostgreSQL Database, Microsoft SQL Server Database, Oracle Database, SAP (Systems, Applications, & Items) Database, and IBM DB2 Database.

The item recommendation system 300 and/or the system components thereof can be implemented using a suitable manner of wired and/or wireless communication. Accordingly, the item recommendation system 300 can include software and/or hardware components configured to implement the wired and/or wireless communication. Further, the wired and/or wireless communication can be implemented using a singular or plural combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Example PAN protocol(s) can include Bluetooth, Zigbee, Wireless Universal Serial Bus (USB), Z-Wave, etc.; example LAN and/or WAN protocol(s) can include Institute of Electrical and Electronic Engineers (IEEE) 802.3 (also known as Ethernet), IEEE 802.11 (also known as WiFi), etc.; and example wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, example communication hardware can include wired communication hardware including, for example, at least one data buses, such as, for example, universal serial bus(es), at least one networking cables, such as, for example, coaxial cable(s), optical fiber cable(s), and/or twisted pair cable(s), any other suitable data cable, etc. Further example communication hardware can include wireless communication hardware including, for example, at least one radio transceivers, at least one infrared transceivers, etc. Additional example communication hardware can include at least one networking components (e.g., modulator-demodulator components, gateway components, etc.).

In many embodiments, the item recommendation system 300 can be suitable to perform the computer-implemented method for dynamic item discovery using the multi-dimensional ranker via the dynamic item discovery system 370 and the multi-dimensional ranker component 373, such as the example embodiment illustrated and described with reference to FIG. 4. In these or other example embodiments, one or more of the activities/steps of the example embodiment of the computer-implemented method 400 for ranking candidate items using a multi-dimensional ranker can be implemented as one or more computing instructions configured to run at one or more processors and configured to be stored at one or more non-transitory computer readable media. Such non-transitory computer readable media can be part of the item recommendation system 300, the system components, and/or the other system components thereof. The processor(s) can be similar or identical to the processor(s) described above with respect to the computer system 100 (FIG. 1). In some embodiments, the example embodiment of the computer-implemented method 400 for ranking candidate items using a multi-dimensional ranker of FIG. 4 (described below) and other steps/activities that can be included therein can include using a distributed network including distributed memory architecture to perform the associated steps/activities. This distributed architecture can reduce the impact on the network 330 and the item recommendation system 300 resources to reduce congestion in bottlenecks while still allowing data to be accessible from a central location.

FIG. 4 illustrates a flowchart of a computer-implemented method for ranking candidate items using a multi-dimensional ranker, according to an example embodiment.

The computer-implemented method 400 for ranking candidate items using a multi-dimensional ranker can be performed by a computer-readable medium storing instructions that, when executed by a processor, can cause the processor to perform the computer-implemented method 400 for ranking candidate items using a multi-dimensional ranker, and/or a system including one or more processors and one or more non-transitory computer-readable media storing computing instructions that, when executed on the one or more processors, can perform various processes that can include the computer-implemented method 400 for ranking candidate items using a multi-dimensional ranker (e.g., the item recommendation system 300 that includes the dynamic item discovery system 370 with the multi-dimensional ranker component 373 and/or the architecture thereof as illustrated and described with reference to FIG. 3A and FIG. 3B, respectively).

In an embodiment, the computer-implemented method 400 for dynamic item discovery using the multi-dimensional ranker can include receiving candidate recommended items at least partially based on at least one item included in routine reorders of a user (step 401).

For each candidate recommended item from among the candidate recommended items, steps 402-406, or a portion thereof, can be performed.

The method can include embedding dimension features associated with each dimension from among multiple dimensions as respective fixed-length embedding vectors (step 402), with the multiple dimensions including a user preference dimension, a department affinity dimension, a model suitability dimension, and an item conversion potential dimension. The dimension features for the item conversion potential dimension include item features associated with a candidate recommended item from among the candidate recommended items for the user.

The method can also include combining the respective fixed-length embedding vectors of the dimension features associated with the multiple dimensions into a combined feature vector (step 403).

Additionally, the method can include inputting the combined feature vector to a deep neural network (DNN) model to generate a ranking score (step 404), which represents a predicted likelihood that the user will engage with the candidate recommended item from among the candidate recommended items for the user.

The method can further include obtaining dimension-specific scores from intermediate layers of the DNN model (step 405), with the dimension-specific scores including a user preference score, a department affinity score, a model suitability score, and an item conversion potential score, and with each of the dimension-specific scores being output by a small multilayer perceptron (MLP) network applied to a respective fixed-length embedding vector from among the respective fixed-length embedding vectors, independently.

The method can also include deriving a final score by incorporating the ranking score with respective weighted contributions for each dimension of the multiple dimensions (step 406).

The method can include ranking the candidate recommended items as ranked candidate recommended items based on the final score for each candidate recommended item from among the candidate recommended items (step 407).

In an embodiment, the method can include inputting the combined feature vector to the DNN model to generate the ranking score, further including applying a sigmoid function to the combined feature vector.

In an embodiment, the method can further include generating the candidate recommended items of at least one recall type (e.g., similar item (SI), complimentary item (CI), cross-pollination item (XP)) using at least one recall type model.

In an embodiment, the method can further include receiving user data associated with the user from at least one of a database system or dynamic feedback, where the user data includes orders of the user, browsing behaviors of the user, and user engagement signals of the user; and analyzing the user data from the database system for at least one of the items included in the routine reorders of the user, frequencies of orders of the user, categories of the orders of the user, and seasonal patterns of the orders of the user.

In an embodiment, the method can further include modifying at least one of weights or biases of the recall type model, a selection of the recall type model, the ranked candidate recommended items, or the respective weighted contributions for each dimension of the multiple dimensions based on one or more of dynamic user engagement signals of the user, dynamic browsing behaviors of the user, or dynamic signs of user engagement fatigue exhibited by the user.

In an embodiment, the method can further include displaying at least one recommended item that corresponds to at least one ranked candidate recommended item from among the ranked candidate recommended items based on at least one of a predetermined final value or a predetermined ranking position.

This innovative approach can enhance user engagement and satisfaction by blending familiar items from routine reorders with exploration of novel candidate recommended items, which can provide consistently relevant and/or personalized recommendations even as user preferences evolve. Embodiments of the ranking candidate items using a multi-dimensional ranker can break the routine order loop of a user by providing personalized discovery recommendations (complementary, similar, cross-category, and/or a blend) in response to user engagement with routine order items. This approach can optimize processing efficiency, resource utilization, and scalability, enhancing an ecommerce ecosystem's computer functionalities.

The methods and systems described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these example embodiments will be apparent to those skilled in the art and may be made without departing from the scope or spirit of these disclosures.

Embodiments disclosed herein relate to a computer-implemented method for ranking candidate items using a multi-dimensional ranker; as well as a system and one or more non-transitory computer-readable media that can implement the computer-implemented method.

Embodiments of the computer-implemented method can include the computer-implemented method 400 for ranking candidate items using a multi-dimensional ranker, as illustrated and described with reference to the example embodiment of FIG. 4.

The computer-readable media can store computing instructions that, when executed on one or more processors, perform various processes including the computer-implemented method.

The system can comprise one or more processors and one or more non-transitory computer-readable media storing computing instructions that, when executed on the one or more processors, perform various processes including the computer-implemented method. Embodiments of the system can include the system (e.g., the item recommendation system 300) that includes the dynamic item discovery system (e.g., the dynamic item discovery system 370) with the multi-dimensional ranker component (e.g., the multi-dimensional ranker component 373), such as illustrated and described with reference to the example embodiment of FIG. 3A. Embodiments of the architecture of the system can include the architecture of the dynamic item discovery system using a multi-dimensional ranker component, such as illustrated and described with reference to the example embodiment of FIG. 3B.

Although example embodiments of a computer-implemented method for ranking candidate items using a multi-dimensional ranker have been illustrated and described herein, it shall be understood by those skilled in the art that various changes may be made without departing from the spirit or scope of the disclosure. Accordingly, the disclosure of the example embodiments is intended to be illustrative of the scope of the disclosure and is not intended to be limiting. It is intended that the scope of the disclosure shall be limited only to the extent required by the appended claims.

Replacement of at least one claimed element constitutes reconstruction and not repair. Additionally, benefits, other advantages, and solutions to problems have been described regarding example embodiments. The benefits, advantages, solutions to problems, and any element or elements that may cause any benefit, advantage, or solution to occur or become more pronounced, however, are not to be construed as critical, required, or essential features or elements of any or all the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a processor; and
a non-transitory computer-readable medium storing computing instructions that, when executed on the processor, cause the processor to perform operations comprising:
for each candidate recommended item from among candidate recommended items:
embedding, by a multi-dimensional ranker component, dimension features associated with each dimension from among multiple dimensions as respective embedding vectors, wherein the multiple dimensions include a user preference dimension, a department affinity dimension, a model suitability dimension, and an item conversion potential dimension, and wherein the dimension features for the item conversion potential dimension include item features associated with a candidate recommended item from among the candidate recommended items for a user;
combining, by the multi-dimensional ranker component, the respective embedding vectors of the dimension features associated with the multiple dimensions into a combined feature vector;
inputting, to a deep neural network (DNN) model included in the multi-dimensional ranker component, the combined feature vector to generate a ranking score, wherein the ranking score represents a predicted likelihood that the user will engage with the candidate recommended item from among the candidate recommended items; and
deriving a final score, by the multi-dimensional ranker component, by incorporating the ranking score with respective weighted contributions for each dimension of the multiple dimensions; and
ranking the candidate recommended items as ranked candidate recommended items based on the final score for each candidate recommended item from among the candidate recommended items.

2. The system of claim 1, wherein the operations further comprise:
generating, by a multi-model recalls component, the candidate recommended items at least partially based on at least one item included in routine reorders of the user.

3. The system of claim 2, wherein the operations further comprise:
receiving, by the multi-dimensional ranker component, the candidate recommended items, as generated, from the multi-model recalls component.

4. The system of claim 1, wherein the operations further comprise:
obtaining, by the multi-dimensional ranker component, dimension-specific scores from intermediate layers of the DNN model,
wherein the dimension-specific scores include a user preference score, a department affinity score, a model suitability score, and an item conversion potential score.

5. The system of claim 4, wherein the dimension-specific scores from the intermediate layers of the DNN model are output by a multilayer perceptron (MLP) network applied to the respective embedding vectors, independently.

6. The system of claim 1, wherein the operations further comprise:
generating, by a multi-model recalls component, the candidate recommended items of at least one recall type using at least one recall type model, wherein the at least one recall type includes a similar item (SI), a complimentary item (CI), or a cross-pollination item (XP).

7. The system of claim 6, wherein the operations further comprise:
receiving, by a user profiling component, user data associated with the user from at least one of a database system or a dynamic feedback loops component, wherein the user data includes orders of the user, browsing behaviors of the user, and user engagement signals of the user.

8. The system of claim 7, wherein the operations further comprise:
analyzing, by the user profiling component, the user data from the database system for at least one of at least one item included in routine reorders of the user, frequencies of orders of the user, categories of the orders of the user, and seasonal patterns of the orders of the user.

9. The system of claim 8, wherein the operations further comprise:
modifying, by the dynamic feedback loops component, at least one of weights or biases of the at least one recall type model, a selection of the at least one recall type model, the ranked candidate recommended items, or the respective weighted contributions for each dimension of the multiple dimensions based on one or more of dynamic user engagement signals of the user, dynamic browsing behaviors of the user, or dynamic signs of user engagement fatigue exhibited by the user.

10. The system of claim 1, wherein the operations further comprise:
displaying at least one recommended item that corresponds to at least one ranked candidate recommended item from among the ranked candidate recommended items based on at least one of at least one predetermined final value or at least one predetermined ranking position.

11. A computer-implemented method comprising:
receiving candidate recommended items at least partially based on at least one item included in routine reorders of a user;
for each candidate recommended item from among the candidate recommended items:
embedding dimension features associated with each dimension from among multiple dimensions as respective fixed-length embedding vectors, wherein the multiple dimensions include a user preference dimension, a department affinity dimension, a model suitability dimension, and an item conversion potential dimension, wherein the dimension features for the item conversion potential dimension include item features associated with a candidate recommended item from among the candidate recommended items for the user,
combining the respective fixed-length embedding vectors of the dimension features associated with the multiple dimensions into a combined feature vector,
inputting the combined feature vector to a deep neural network (DNN) model to generate a ranking score, wherein the ranking score represents a predicted likelihood that the user will engage with the candidate recommended item from among the candidate recommended items for the user,
obtaining dimension-specific scores from intermediate layers of the DNN model, wherein the dimension-specific scores include a user preference score, a department affinity score, a model suitability score, and an item conversion potential score, and wherein each of the dimension-specific scores is output by a multilayer perceptron (MLP) network applied to a respective fixed-length embedding vector from among the respective fixed-length embedding vectors, independently, and
deriving a final score by incorporating the ranking score with respective weighted contributions for each dimension of the multiple dimensions; and
ranking the candidate recommended items as ranked candidate recommended items based on the final score for each candidate recommended item from among the candidate recommended items.

12. The computer-implemented method of claim 11, wherein the inputting the combined feature vector to the DNN model to generate the ranking score further comprises:
applying a sigmoid function to the combined feature vector.

13. The computer-implemented method of claim 11, further comprising:
generating the candidate recommended items of at least one recall type using at least one recall type model, wherein the at least one recall type includes a similar item (SI), a complimentary item (CI), or a cross-pollination item (XP).

14. The computer-implemented method of claim 11, further comprising:
receiving user data associated with the user from at least one of a database system or dynamic feedback, wherein the user data includes orders of the user, browsing behaviors of the user, and user engagement signals of the user; and
analyzing the user data from the database system for at least one of the at least one item included in the routine reorders of the user, frequencies of orders of the user, categories of the orders of the user, and seasonal patterns of the orders of the user.

15. The computer-implemented method of claim 14, further comprising:
modifying at least one of weights or biases of the at least one recall type model, a selection of the at least one recall type model, the ranked candidate recommended items, or the respective weighted contributions for each dimension of the multiple dimensions based on one or more of dynamic user engagement signals of the user, dynamic browsing behaviors of the user, or dynamic signs of user engagement fatigue exhibited by the user.

16. The computer-implemented method of claim 11, further comprising:
displaying at least one recommended item that corresponds to at least one ranked candidate recommended item from among the ranked candidate recommended items based on at least one of at least one predetermined final value or at least one predetermined ranking position.

17. A non-transitory computer-readable medium storing instructions that, when executed by a processor, cause the processor to perform operations comprising:
receiving candidate recommended items at least partially based on at least one item included in routine reorders of a user;
for each candidate recommended item from among the candidate recommended items:
embedding dimension features associated with each dimension from among multiple dimensions as respective fixed-length embedding vectors, wherein the multiple dimensions include a user preference dimension, a department affinity dimension, a model suitability dimension, and an item conversion potential dimension, wherein the dimension features for the item conversion potential dimension include item features associated with a candidate recommended item from among the candidate recommended items for the user,
combining the respective fixed-length embedding vectors of the dimension features associated with the multiple dimensions into a combined feature vector,
inputting the combined feature vector to a deep neural network (DNN) model to generate a ranking score, wherein the ranking score represents a predicted likelihood that the user will engage with the candidate recommended item from among the candidate recommended items for the user,
obtaining dimension-specific scores from intermediate layers of the DNN model, wherein the dimension-specific scores include a user preference score, a department affinity score, a model suitability score, and an item conversion potential score, and
deriving a final score by incorporating the ranking score with respective weighted contributions for each dimension of the multiple dimensions; and
ranking the candidate recommended items as ranked candidate recommended items based on the final score for each candidate recommended item from among the candidate recommended items.

18. The non-transitory computer-readable medium of claim 17, wherein the operations further comprise:
displaying at least one recommended item that corresponds to at least one ranked candidate recommended item from among the ranked candidate recommended items based on at least one of at least one predetermined final value or at least one predetermined ranking position.

19. The non-transitory computer-readable medium of claim 17, wherein each of the dimension-specific scores is output by a multilayer perceptron (MLP) network applied to a respective fixed-length embedding vector from among the respective fixed-length embedding vectors, independently.

20. The non-transitory computer-readable medium of claim 18, wherein each of the dimension-specific scores is output by a multilayer perceptron (MLP) network applied to the dimension features of each dimension.
